(19) United States
(12) Patent Application Publication
(10) Pub. No.: US 2016/0261985 A1
(43) Pub. Date: Sep. 8, 2016

(54) Mobile smart phone device based system and method for facilitating the meeting of two or more geographically nearby located people interested in synchronously performing a social networking activity

(71) Applicant: Amit Surve, Glen Allen, VA (US)

(72) Inventor: Amit Surve, Glen Allen, VA (US)

(21) Appl. No.: 14/639,314

(22) Filed: Mar. 5, 2015

(51) Int. Cl. H04W 4/02; H04L 12/58; H04L 29/08

(52) U.S. Cl. CPC H04W 4/023; H04L 67/10; H04L 51/046

(57) ABSTRACT

A mobile smart phone device based system and method for expressing an interest in performing a social networking activity form the available activities within the application, referred as categories and sub-categories; enabling finding of and contacting to the other users of this application that are interested in performing the same activity synchronously coinciding in time, and enabling filtering by age, gender and distance, of such users that are geographically nearby located; and, eventually enabling an instant communication between such users via the application built-in instant chat messaging system.

### BACKGROUND OF THE INVENTION

Today, individuals often find themselves spending leisure time on social-networking websites. Yet this social-networking largely remains virtual; meaning it doesn't motivate individuals in meeting in person and participating in any social networking activity, such as playing together some sports or working together on an assignment at a public library, etc. There are situations during the leisure time where people would like to spend some time with other like-minded people, in participating in a common social-networking activity that they are commonly interested in. However if the individual's friend-circle or social-group is pre-occupied with work or other priorities at that point in time, then that individual's social interests are lost. Eventually that individual ends up spending that time at home or at some other indoor place, simply browsing social-networking websites and only doing a virtual networking.

### BRIEF SUMMARY OF THE INVENTION

The proposed mobile smart phone device based system and method is meant for facilitating the arrangement of social networking meetings between two or more individuals seeking to perform a common social networking task or activity. The invention relates to providing a system and method for allowing contacting, communication and eventually in-person meeting between two or more individuals relating to performing a social networking activity synchronously, coinciding with time.

### DETAILED DESCRIPTION OF THE INVENTION

1. To begin with, the system is comprised of main-categories and respective sub-categories. The main categories are like ‘Socialize’, ‘Sports Time’, etc. And the sub-categories include ‘Baseball’, ‘Soccer’, ‘Hangout’, ‘Board Game’, etc:

A) Socialize
a. Hangout
b. On A Business Trip
c. Wine n Dine
d. Shopping-partner

B) Sports Time
a. American Football
b. Baseball
c. Basketball
d. Cricket
e. Soccer
f. Tennis
g. Something Else

C) Outdoor Fun
a. Biking Partner
b. Let's Go Hiking
c. Walk-A-Dog
d. See Places (Tourism)
e. Other

D) Indoor Stuff
a. Hit The Gym
b. Chess Corner
c. Play Your Cards
d. Other Board Games
e. Something Else

E) Community.
a. Meet A Geek
b. Kids-Play-Date
c. Senior Citizens

2. Each of the above main-category and sub-categories will be configurable via application administration, and categories and sub-categories could be added, removed, or altered based on application management decision.

3. System allows user to register with one or more sub-categories, hence allowing them to express their interest in performing the specific social networking activity.

4. The categories and sub-categories could be configured according to certain minimum-age, and hence some of the categories, such as ‘Hangout’, or ‘Wine-n-Dine’ may not be visible to users not meeting a specific age criteria.

5. System allows user to view the other users that are interested in performing a common activity, further allowing them to express their interest in communicating, using application feature called ‘Poke’.

6. A user receiving a ‘Poke’ request from other user, has an option of either ‘Accepting’ the poke of ignoring the same.

7. If the user accepts the ‘Poke’ request from other users, then both such users will see each other in their ‘Chat List’, an application interface that displays a list of people who one can chat with.

8. User can contact and communicate using application built-in instant chat communication system, thereby communicating a plan to meet in person, deciding upon location, time, etc.

9. User can repeat any or all of the above steps from 1 through 8, for multiple sub-categories

10. System provides user-interface navigation for users to navigate from Categories, Sub-Categories, Poke-List, Chat-List and Instant-Chat window.

I claim:

1. A mobile smart phone device based system and method for facilitating an arrangement for in-person real meeting of two or more people including a first user and second user or users comprising: (a) allowing said first user to register with an interested social networking activity from the available activities within application, (b) expressing a real-time interest in that social networking activity; (C) capturing first user's current location, and (d) allowing such registered users to be viewable in the search-result for the user or users who expressed interest in that social networking activity, (f) enabling filtering of users by distance, age and gender (e) and eventually enabling an instant communication between such users using the application built-in instant chat messaging system.

2. The method of claim 1, wherein said location of users is determined using mobile smart phone device's built-in geo-location service.

3. The method of claim 1, wherein a list of parent social activities, referred to as categories and a list of child social activities, referred to as sub-categories, are provided as application interface.

4. The method of claim 1, a list of categories and sub-categories is comprised of, but not limited to, and may change:
A) Socialize
a. Hangout
b. On A Business Trip
c. Wine n Dine
d. Shopping-partner
B) Sports Time
a. American Football
b. Baseball
c. Basketball
d. Cricket
e. Soccer
f. Tennis
g. Something Else
C) Outdoor Fun
a. Biking Partner
b. Let's Go Hiking
c. Walk-A-Dog
d. See Places (Tourism)
e. Other
D) Indoor Stuff
a. Hit The Gym
b. Chess Corner
c. Play Your Cards
d. Other Board Games
e. Something Else
E) Community.
a. Meet A Geek
b. Kids-Play-Date
c. Senior Citizens

5. The method of claim 4, wherein users are presented with categories on the landing page of the application.

6. The method of claim 4, wherein users navigate to sub-categories by tapping on any of the categories presented on the landing page of the application.

7. The method of claim 1, further comprising providing users an interface for registering with a sub-category, thereby allowing users to express their interest in that specific sub-category.

8. The method of claim 7, wherein said first user is asked to fill in the screen-name and caption for that specific sub-category.

9. The method of claim 7, wherein said first user is presented with a ‘Register’ button to register to a sub-category.

10. The method of claim 1, wherein the users who registered are presented with a ‘user-filter’ form so as to filter their search by distance, age and gender.

11. The method of claim 1, wherein to express an interest, the users can ‘poke’ the other users that match the search-criteria, using ‘Poke’ icon presented on the application interface.

12. The method of claim 1, wherein when the users notice a ‘poke’ activity from other users, the user then can either accept or ignore the ‘poke’ activity, presenting a user a further choice of whether to communicate with the other user or not.

13. The method of claim 1, wherein users can see each other in application interface called ‘Chat List’ after the users accept the ‘Poke’ invitation.

14. The method of claim 13, wherein a chat list shows a list of mutually accepted users and the list shows a brief description of the user, such as user screen-name, user caption, user's age, user's gender and distance.

15. The method of claim 1, wherein users can communicate with each other using the application built-in instant chat messaging system.

16. The method of claim 1, wherein after the communication is established, users can eventually decide upon meeting in person and performing any social networking activity that they are interested in participating synchronously, coinciding in time.
